(19) United States
(12) Patent Application Publication
(10) Pub. No.: US 2021/0000290 A1
(43) Pub. Date: Jan. 7, 2021

(54) BEVERAGE PREPARATION MACHINE WITH AN IMPROVED USER INTERFACE

(71) Applicant: SOCIETE DES PRODUITS NESTLE S.A., Vevey (CH)

(72) Inventors: Gregory Savioz, Saxonne (CH); Youcef Ait Bouziad, Echandens (CH); Fabien Ludovic Agon, Veleyres-Sous-Rances (CH)

(21) Appl. No.: 16/976,978

(22) PCT Filed: Feb. 27, 2019
(86) PCT No.: PCT/EP2019/054815

§ 371 Date: Aug. 31, 2020

(30) Foreign Application Priority Data
Mar. 2, 2018 (EP) 18159612.3

(51) Int. Cl. A47J 31/44; G06F 3/0362; G06F 3/01

(52) U.S. Cl. CPC A47J 31/4407; G06F 3/016; G06F 3/0362

(57) ABSTRACT

There is described a beverage preparation machine, comprising a user interface for allowing a user interacting with the machine, the user interface comprising an input device (1, 1′, 1″) for selecting a value of a beverage parameter within a value range, wherein the input device (1, 1′, 1″) is a physical element, such as a knob or a slider, movable within a preferably finite movement range, and wherein the position of the input device (1, 1′, 1″) within the movement range corresponds to a selected value of the value range; a beverage preparation arrangement configured for preparing a beverage from one or more ingredients taking into account the selected value; a controller for controlling the user interface and the preparation arrangement; wherein the user interface further comprises a driver (2) connected to the input device (1, 1′, 1″) for providing haptic feedback to a user moving the input device (1, 1′, 1″). There is also described a method for preparing a beverage with such a beverage preparation machine.

### FIELD OF THE INVENTION

The present invention relates to a beverage preparation machine with an improved user interface. The present invention relates in particular to a beverage preparation machine with a user interface that guides users in setting beverage parameters and/or prevents the selection of unappropriated parameters.

### BACKGROUND ART

For the purpose of the present description, a “beverage” is meant to include any human-consumable liquid substance, such as coffee, tea, hot or cold chocolate, milk, soup, baby food or the like.

Beverage preparation machines usually mix, in a beverage preparation arrangement, one or more ingredients, such as for example, but not exclusively: ground coffee, tealeaves, chocolate powder, lyophilized milk, lyophilized soup, lyophilized baby food, etc.; with a carrier liquid, for example water, and dispense the resulting beverage into an appropriate receptacle. Some beverage preparation machines for example use ingredients provided in capsules, wherein the content of a capsule typically corresponds to the quantity required for the preparation of a beverage serving.

For the purpose of the present description, a “capsule” is meant to include any pre-portioned beverage ingredient or combination of ingredients (hereafter called “ingredient”) within an enclosing packaging of any suitable material such as plastic, aluminium, a recyclable and/or bio-degradable material and combinations thereof, including a soft pod or a rigid cartridge containing the ingredient.

Beverage preparation machines often allow users to customize their beverage, typically by adjusting one or more beverage parameters, such as, for example but not exclusively: the beverage volume, the beverage temperature, the presence of additional ingredients such as: milk, sugar, salt, etc.; the proportion of different beverage ingredients, such as for example milk and coffee, etc. Thus, when confronted to such a beverage preparation machine, the user has to make choices such as for example select the length of his cup and/or other parameters. It may become difficult for example when it comes to multiple ingredients beverages and the user has to avoid a cup overflow and remain within reasonable proportions and volumes, compared to the content of a capsule for instance. It may be even more difficult when both products come out of a same capsule having two separate compartments.

In some beverage preparation machines, the user is guided towards best in-cup results using pictograms that show a preferred parameter value for a particular ingredient or capsule. Some beverage preparation machine also use capsule and/or ingredient recognition systems to pre-set some beverage parameters like cup length, temperature, etc.

There is however still a need for a beverage preparation machine with an improved user interface that provides an interactive interface to efficiently communicate with the user and guide him towards the best in-cup results.

### SUMMARY OF THE INVENTION

These aims and other advantages are achieved by a beverage preparation machine, comprising a user interface for allowing a user interacting with the machine, the user interface comprising an input device for selecting a value of a beverage parameter within a value range, wherein the input device is a physical element, such as a knob or a slider, movable within a preferably finite movement range, and wherein the position of the input device within the movement range corresponds to a selected value of the value range; a beverage preparation arrangement configured for preparing a beverage from one or more ingredients taking into account the selected value; a controller for controlling the user interface and the preparation arrangement; wherein the user interface further comprises a driver connected to the input device for providing haptic feedback to a user moving the input device.

The driver is preferably configurable by the controller to adjust the haptic feedback to a nature of the beverage parameter and/or to a selected beverage to be prepared by the beverage preparation machine. The driver is for example configurable by the controller to define a finite number of discrete stable positions of the input device within the movement range, each discrete position corresponding to a different discrete value of the beverage parameter and/or to limit the movements of the input device within a range smaller than the movement range. Preferably, the driver is furthermore configured to be able to automatically move the input device.

In embodiments, the user interface comprises a first input device for selecting a value of a first beverage parameter within a first value range, wherein the first input device is a physical element, such as a knob or a slider, movable within a preferably finite first movement range, and wherein the position of the first input device within the first movement range corresponds to a selected value of the first value range; a first driver connected to the first input device for providing haptic feedback to a user moving the first input device and/or for moving the first input device; a second input device for selecting a value of a second beverage parameter within a second value range, wherein the second input device is a physical element, such as a knob or a slider, movable within a preferably finite second movement range, and wherein the position of the second input device within the second movement range corresponds to a selected value of the second value range; a second driver connected to the second input device for providing haptic feedback to a user moving the second input device and/or for moving the second input device; the beverage preparation arrangement being for preparing a beverage from one or more ingredients taking into account the selected value of the first beverage parameter and the selected value of the second beverage parameter.

Preferably, the controller is configured to check whether the selected value of the first beverage parameter and the selected value of the second beverage parameter fulfil a predefined beverage condition, and to automatically modify at least one of the selected value of the first beverage parameter and the selected value of the second beverage parameter, if the predefined beverage condition is not fulfilled. Preferably, the controller is furthermore configured to automatically move the first input device to a position corresponding to an automatically modified value of the first beverage parameter and to automatically move the second input device to a position corresponding to an automatically modified value of the second beverage parameter.

These aims and other advantages are also achieved by a method for preparing a beverage with a such a beverage preparation machine, the method comprising the steps of selecting a beverage to be prepared by the preparation machine; adjusting a haptic feedback of the input device to the selected beverage.

Adjusting the haptic feedback for example comprises configuring a force feedback to define a finite number of discrete stable positions of the input device and/or configuring a force feedback to limit the movements of the input device to a range smaller than the movement range.

In embodiments, the method further comprises the steps of checking whether the selected value is compatible with the selected beverage and/or with values of other beverage parameters of the selected beverage; correcting the selected value and/or a value of the other beverage parameters if the result of the previous step of checking is negative; automatically moving an input device of the user interface if a value of a beverage parameter selectable through the input device is corrected in the previous step of correcting.

### BRIEF DESCRIPTION OF THE FIGURES

The invention will be better understood thanks to the following detailed description of embodiments of the invention with reference to the attached drawings, in which:

FIG. 1 shows an embodiment of an input device of a user interface of a beverage preparation machine according to the invention;

FIG. 2 shows another embodiment of an input device of a user interface of a beverage preparation machine according to the invention;

FIG. 3 is a schematic illustration of an adjustable force feedback profile for an input device of a user interface of a beverage preparation machine according to the invention;

FIG. 4 illustrates another example of an adjustable force feedback profile for an input device of a user interface of a beverage preparation machine according to the invention;

FIGS. 5A and 5B show a part of a user interface of a beverage preparation machine according to an embodiment of the invention, comprising two input devices;

FIG. 6 is a block diagram of the method of selecting and customizing a beverage according to an embodiment of the invention;

FIGS. 7A to 7F illustrate at least part of a user interface of a beverage preparation machine according to an embodiment of the invention at different moments while selecting and/or customizing a beverage;

FIGS. 8A to 8F illustrate at least part of a user interface of a beverage preparation machine according to another embodiment of the invention at different moments while selecting and/or customizing a beverage.

### DETAILED DESCRIPTION OF THE INVENTION

The beverage preparation machine of the invention comprises a user interface having at least one input device for setting the value of at least one beverage parameter. The beverage parameter is for example a volume, a temperature, a consistency, a concentration, a flavour, or any other appropriate parameter of at least one component of the beverage. The parameter value set with the input device will then be read by a controller of the beverage preparation machine and used by the beverage preparation arrangement of the preparation machine, typically for preparing the next beverage. The controller of the beverage preparation machine typically comprises one or more electronic computing device such as microcontrollers, microprocessors, etc., able to execute at least parts of a computer program and perform operations using input data such as for example, but not exclusively, input signals from sensors and/or user input from a machine user interface, in order for example to generate command signals to control the various elements of the beverage preparation machine, such as for example, but not exclusively, the user interface, the beverage preparation arrangement, a display, etc.

According to the invention, the input device is a physical device, for example a slider and/or a knob, whose position, for example its linear and/or angular position, determines the value of a respective parameter. Preferably, the input device is movable within a limited movement range, for example a limited linear range or a limited angular range. The input device is furthermore connected to a driver for providing haptic feedback, for example force feedback, to a user moving the input device.

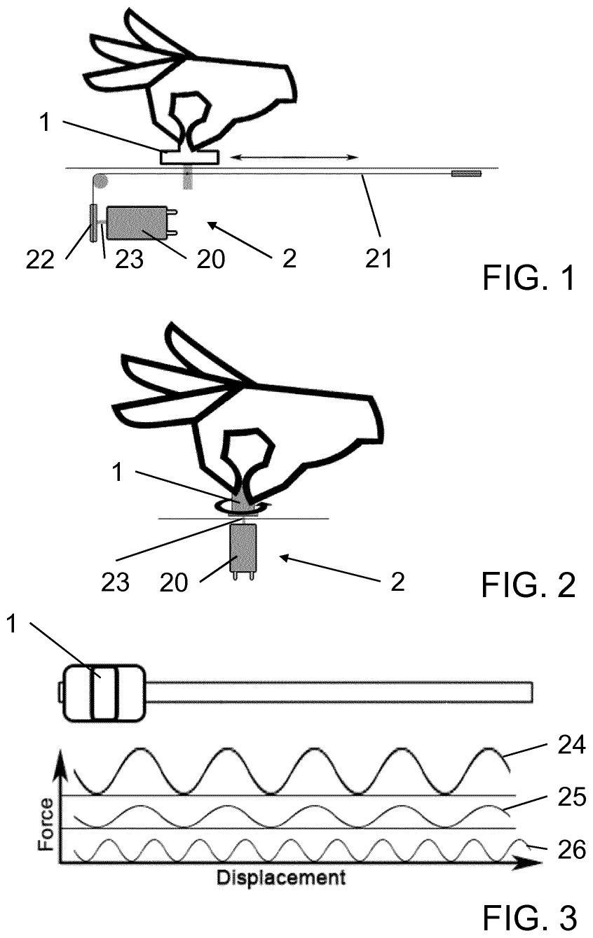

FIG. 1 shows an example of an input device 1 according to embodiments of the invention, in the form of a slider. The linear position of the slider within its finite limited displacement range is typically used to set the value of a respective beverage parameter. In embodiments, the position of the slider is determined by a controller of the beverage preparation machine from an electrical signal emitted by the slider. Alternatively or in combination thereof, the input device further comprises a position sensor for determining the position of the slider, for example a linear potentiometer or a linear encoder coupled to the slider, the output of which is representative of the position of the slider and transmitted to a controller of the beverage preparation machine. The determined position is then preferably translated into a value, using for example a correspondence table and/or a correspondence formula, which is for example stored in a memory of the beverage preparation machine. In the example illustrated in FIG. 1, the driver 2 of the input device 1 comprises an electric motor 20 and a belt 21 connecting the motor 20 to the slider, such that when the slider is moved, it moves the belt 21 and consequently rotates the motor's axis 23. The belt 21 is for example driven by fixed pulleys and/or other guiding elements in a loop extending at least partly along the input device's trajectory. The belt 21 is preferably attached to the input device 1 and driven around at least part of the periphery of a disk 22 fixed onto the motor's axis 23. Haptic feedback is typically generated by applying to the slider 1 forces from the motor 20 through the belt 21. As explained further below, the motor 20 is typically controlled by a controller of the beverage preparation machine, and the nature, intensity and/or direction of the applied force preferably depends on the determined position of the slider 1.

FIG. 2 shows another example of an input device 1 according to embodiments of the invention in the form of a knob. The angular position of the knob within a preferably limited angular range is typically used to set the value of a respective beverage parameter. In embodiments, the angular position of the knob is determined by a controller of the beverage preparation machine from an electrical signal emitted by the knob. Alternatively or in combination thereof, the input device further comprises a position sensor for determining the angular position of the knob, for example a rotational potentiometer or a rotational encoder coupled to the knob, the output of which is representative of the angular position of the knob and transmitted to a controller of the beverage preparation machine. The determined position is then preferably translated into a value, using for example a correspondence table and/or a correspondence formula, which is for example stored in a memory of the beverage preparation machine. In the example illustrated in FIG. 2, the driver 2 of the input device 1 comprises an electric motor 20 whose axis 23 is directly connected to the knob 1, such that when the knob 1 is turned, it rotates the axis 23. Haptic feedback is typically generated by applying to the knob 1 forces from the motor 20 through the axis 23. As explained further below, the motor 20 is typically controlled by a controller of the beverage preparation machine, and the nature, intensity and/or direction of the applied force preferably depends on the determined angular position of the knob 1.

Other input devices are possible within the frame of the invention, such as for example, but not exclusively, pushbuttons, sliders with non-linear trajectories, etc. A beverage preparation machine having a user interface comprising a combination of input devices of different types is furthermore possible within the frame of the invention.

As will be explained further below, in embodiments the driver 2 is furthermore configured to be able to move the input device 1 in order to automatically adjust the value of the respective parameter if necessary or desired for a particular beverage.

The driver 2 is preferably controlled and/or configured by a controller of the beverage preparation machine, which preferably also controls the beverage preparation arrangement of the beverage preparation machine. The beverage preparation arrangement for example comprises a coffee extraction unit, a tea infusion unit, a milk foaming unit, a mixing unit, etc. and/or any combination thereof.

The driver 2 is preferably configurable to provide an adjustable haptic feedback to a user moving the input device 1, depending for example on the nature of the respective beverage parameter and/or of the selected beverage. The type and/or intensity of haptic feedback applied to the input device 1 for example varies with the position of the input device 1, thus typically with the position of the driver 2, for example with the angular position of the motor's axis 23.

With reference to FIG. 3, the driver is for example configurable to provide an adjustable force feedback for providing the sensation to a user moving the input device 1, for example a slider, that the movement range of the input device is divided into a finite number of stable positions. A stable position will for example be perceived by the user at a position of the input device 1 where the force feedback is close to zero. Each position for example corresponds to an appropriate discrete value of the respective beverage parameter. The chart of FIG. 3 schematically illustrates examples of different programmable force feedback schemes for input device 1, each providing a different feeling to a user moving the input device 1. The two upper curves 24 and 25 for example each correspond to a configuration of the driver providing to a user the feeling that the slider's linear range comprises five discrete positions, while the lower waveform 26 corresponds to a configuration providing to a user the feeling that the range comprises ten discrete positions. Accordingly, the input device 1 may be configured to guide the user into choosing one amongst five or respectively ten, preferably predefined, discrete beverage parameter values. Furthermore, the upper curve 24 corresponds to a configuration offering a higher resistance to a user moving the input device 1 from one discrete position to the next, compared to the configurations corresponding to the two lower curves 25 and 26. The number of discrete positions and/or the force amplitude are preferably configurable as appropriate, depending typically on the needs, for example on a predefined number of parameter values and/or on a desired feel of the user interface.

Other types of haptic feedback are furthermore possible within the frame of the invention, as an alternative or in combination with the force feedback described above. The driver may for example be configured to vibrate the input device when the input device is between two stable predefined positions. Alternatively or in combination thereof, the driver may simulate the behaviour of a flexible blade by resisting a displacement of the input device in a given direction with an increasing force, until a stable predefined position is reached and the force drops dramatically.

The adjustment of the haptic feedback of the input device 1 illustrated in FIG. 3 is applied to a slider. The one skilled in the art will however understand that similar configurable haptic feedback adjustments are applicable to any input device according to the invention, for example to a knob, a pushbutton, etc.

Preferably, the user interface further comprises a display for providing additional information to the user. The display for example provides a graphical illustration of the selectable and/or selected beverage parameter values, corresponding for example to the discrete positions of the input device felt by the user. Any type of display is possible within the frame of the invention. Preferably, however, the display is dynamically configurable and adapts to the configuration of the input device achieved by the adjustment of the haptic feedback. The display is for example configurable to provide an illustration of the parameter values selectable with the input device, which typically correspond to stable positions determined by a corresponding configuration of the driver, and/or for highlighting the selected value. The display is for example a LCD screen or any other appropriate configurable display.

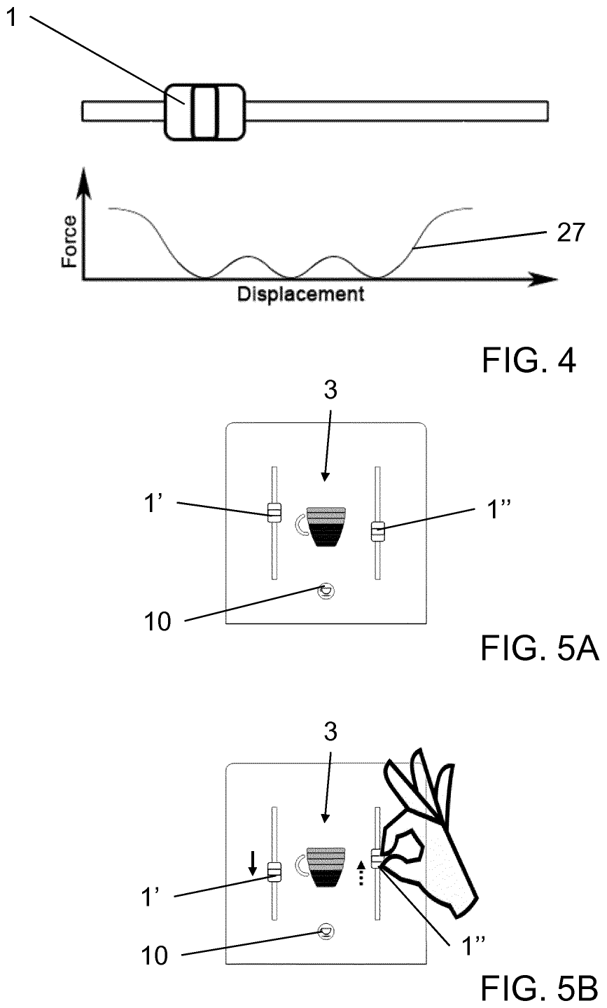

In embodiments, the driver is configured to provide haptic feedback, in particular force feedback, that limits the useful movement range of the input device, for example by increasing the force feedback after a position corresponding to a limit beverage parameter value and/or by automatically returning the input device to said position if it was moved past it. This is for example schematically illustrated in FIG. 4, wherein the curve 27 illustrates a configuration of the driver resulting in the force feedback being adjusted to provide to a user moving the input device 1 the feeling that three discrete positions are defined in a central part of the movement range of the input device 1. Such configuration is for example preferred for some particular beverages in order to avoid the selection of an inappropriate parameter value and/or when the number of possible values for the respective parameter is limited. The exemplary configuration illustrated in FIG. 4 could for example be implemented if the input device 1 was to be used for the customization of an espresso coffee, for which only three beverage volumes are selectable by a user.

In embodiments, the user interface of the beverage preparation machine of the invention comprises two or more input devices as described above, in order for example to allow the simultaneous customization of two or more beverage parameters. A first input device for example allows setting a value of a parameter of a first component of a selected beverage while a second input device allows setting a value of a parameter of a second component of the selected beverage, for example, but not exclusively, the volume of a first component and the volume of a second component of the beverage, a consistency of a first component and a flavour of a second component of the beverage, etc. Alternatively, a first and a second input devices allow setting each the value of another parameter of the same beverage component, for example, but not exclusively, a temperature and a volume of a beverage component, a temperature and a consistency of a beverage component, etc.

FIG. 5A for example illustrates at least part of a machine user interface comprising two input devices 1′, 1″. The selected beverage to be prepared by the beverage preparation machine is for example a beverage comprising two components such as a milk and coffee beverage, for example a cappuccino, a café latte, a café macchiato, etc. The first input device 1′ for example allows setting a volume of a first component, for example coffee, of the resulting beverage, while a second input device 1″ allows setting a volume of a second component, for example milk such as cold, warm and/or foamed milk, of the resulting beverage. Preferably, the user interface comprises a display 3, for example a LCD screen, on which the selected beverage is at least schematically illustrated, showing for example the respective volumes of the beverage components.

Preferably, once a beverage is selected by a user, for example by introducing one or more corresponding ingredient capsules in the beverage preparation machine and/or by choosing a beverage with the machine's user interface, the beverage preparation machine determines and/or retrieves one or more default beverage parameter values, corresponding for example to an optimal and/or a preferred recipe of the selected beverage. Preferably, the drivers of the one or more input devices of the user interface are configured to be able to move their respective input device, and once default parameter values are determined and/or retrieved by the beverage preparation machine, the one or more input devices of the machine's user interface are for example each automatically moved by their drivers to a position corresponding to the default value of the respective parameter, thereby informing the user of the default settings. Preferably, the display 3 is furthermore configured accordingly to display corresponding beverage information. Before the beverage preparation machine starts preparing the selected beverage, the user preferably has the opportunity to customize the beverage by modifying the value of at least some beverage parameters using the one or more input devices of the machine's user interface.

As illustrated in FIG. 5B showing the part of user interface of FIG. 5A being manipulated by a user, the user for example decides to increase the volume of milk by one volume unit by moving the second input device 1″ (dotted arrow). Preferably, the machine controller is configured to verify that the user selection is allowable and/or compatible with the other beverage parameter values. In the present example, the user selection of increasing the milk volume by one volume unit would result in the overall beverage volume exceeding for example a standard receptacle capacity of for example seven volume units and the prepared beverage potentially overfilling the user's cup. The beverage preparation machine thus preferably automatically corrects the coffee volume, for example by reducing the coffee volume by one volume unit, in order to keep the beverage's total volume within an allowable limit. As illustrated in the example of FIG. 5B with the plain arrow, the first input device 1′ that allows setting the coffee volume is automatically moved to the position corresponding to the corrected value. Preferably, the beverage schematically illustrated on the display 3 is also modified to reflect the new beverage component proportions. The user is thereby preferably informed that his action to increase the milk volume induced an automatic reaction of the beverage preparation machine reducing by the same amount the coffee volume in order to keep the overall beverage volume within a set limit, corresponding for example to the maximal volume of a typical receptacle for the selected beverage. In FIG. 5B, the dotted-line arrow illustrates the input device movement initiated by the user, and the full-line arrow illustrates the automatic movement of the input device 1′ due to the machine's reaction to the user's action.

Once the user is satisfied with the selected parameters, the beverage preparation according to said parameters is for example initiated by the user by actuating a corresponding input element of the user interface, for example by pushing a physical or virtual start button, for example a virtual start button 10 displayed in a specific portion of a touch screen of the machine's display 3, identified for example by a specific icon or image. Alternatively or in combination thereof, the beverage preparation is automatically started after a defined delay has lapsed since the last modification of the parameters.

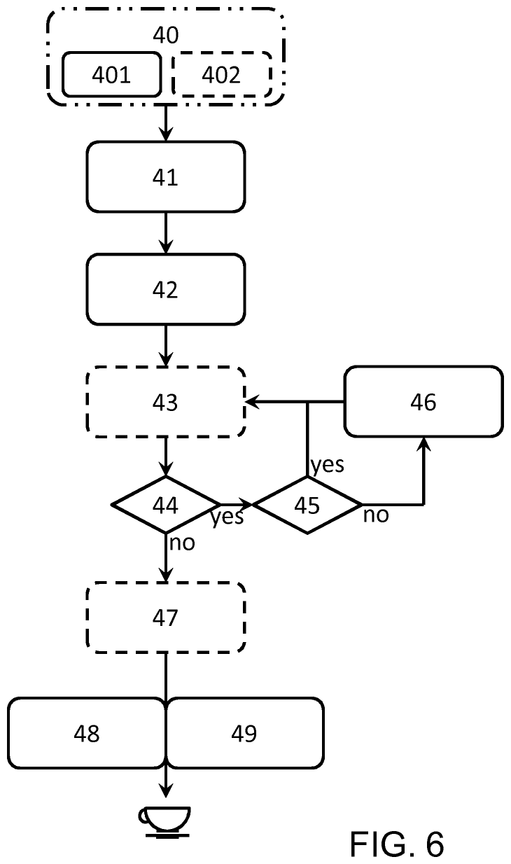

An example of a method of preparing a beverage with a beverage preparation machine according to embodiments of the invention is schematically illustrated in FIG. 6. The method steps illustrated by rectangles in dotted line are user initiated method steps, while the method steps illustrated by rectangles in plain line are machine initiated method steps.

In a first step 40, a beverage is selected. The beverage selection step 40 for example comprises an automatic beverage selection step 401, a manual beverage selection step 402, or a combination thereof.

The automatic beverage selection step 401 for example comprises an automatic recognition by the beverage preparation machine of one or more ingredients for example introduced in the machine by a user, and a selection by the machine controller of a default beverage to be prepared with the recognized one or more ingredients. The one or more ingredients are for example conditioned in one or more capsules, wherein each capsule preferably comprises an identifier and/or beverage preparation parameters that can be read by the machine, for example by a recognition module of the machine's beverage preparation arrangement. Alternatively, or in combination thereof, the automatic beverage selection step 401 comprises selecting a beverage based on an identification of a user of the machine, wherein one or more preferred beverages of the user are for example retrieved from a local or a remote memory storage, directly or indirectly accessible by the machine's controller. Alternatively or in combination with the above, the automatic beverage selection step 401 comprises selecting a beverage based on various parameters such as for example the time of the day, the day of the week, the season, the outside temperature, the type of the beverage preparation machine, the ingredients available in the beverage preparation machine, etc.

The manual beverage selection step 402 typically comprises selecting a beverage by a user of the machine, for example by actuating a corresponding element of the machine's user interface, for example a pushbutton, a particular zone of a touch screen, a remote interface on a mobile device of the user, etc.

In embodiments, the beverage selection step 40 may combine an automatic selection step 401 and a manual selection step 402, for example in that one or more beverages are automatically selected by the machine and suggested to the user, for example via the machine's user interface. The user then selects one beverage amongst the suggested ones, or selects another beverage that was not suggested by the machine. Other combinations of an automatic selection step 401 and a manual selection step 402 are of course possible within the frame of the invention.

In a default values determination step 41, the controller of the beverage preparation machine automatically determines and/or retrieves one or more predefined default values for parameters of the selected beverage. The beverage parameters for example include a volume, a temperature, a consistency, a flavour, or any other appropriate property, of one or more components of the selected beverage. The default beverage parameter values may for example correspond to a preferred and/or optimal recipe of the selected beverage, for example in order to achieve best in-cup result as previously determined for example by a manufacturer, by an administrator and/or by a user of the machine. The default beverage parameter values are for example stored in a memory of the beverage preparation machine accessible to the controller and/or in a memory of an external device directly or indirectly accessible by the controller over a wired and/or wireless communication channel and/or in one or more ingredient capsules introduced in the beverage preparation machine.

In an optional machine preset step 42, preparation parameters are preferably preset to values determined on the basis of the previously determined default beverage parameter values in order for the beverage preparation arrangement to prepare the selected beverage according to the default recipe. The preparation parameters typically include parameters of the beverage preparation arrangement such as for example a volume and/or a temperature of a carrier liquid, typically water, an ingredient processing time and/or type, an ingredient selection, or any other appropriate preparation parameter of the selected beverage's recipe. During the machine preset step 42, the controller furthermore preferably configures the drivers of one or more input devices of the machine's user interface in order to adjust their haptic feedback such as to optimize the selection of the value of one or more respective parameters of the selected beverage. The one or more drivers are for example configured to provide to the user a force feedback providing the feeling of an appropriate number of discrete selection positions, for example by limiting the useful range of the input device and/or by adjusting the number of virtual discrete positions defined along the movement range of the input device, as explained above. The controller furthermore preferably controls the drivers of the one or more input devices to automatically move the respective input device in a position corresponding to the determined default value of the respective beverage parameter.

In a customization step 43, the user may then modify the value of one or more beverage parameters by moving the one or more input devices of the machine's user interface. The user may for example select a volume, a flavour, a temperature, a consistency of one or more beverage components, different from the previously set default value.

In a customization check step 44, the controller checks whether the beverage was customized during the customization step 43, i.e. whether a beverage parameter value different from the previously set value, for example different from the corresponding default value, was selected by a user.

If the outcome of the customization check step 44 is positive, i.e. if a beverage parameter was customized by the user, the controller proceeds with a conformity check step 45 to verify whether the newly selected beverage parameter value is compatible with the selected beverage and/or with the other default and/or modified beverage parameter values. During the conformity check step 45, the controller for example checks whether the beverage parameter value selected by the user during the customization step 43, alone or in combination with the other current parameter values of the selected beverage, satisfies a predetermined condition proper to the selected beverage. If the selected beverage parameter value is a particular volume of a component of the selected beverage, the controller for example checks whether the selected volume and/or the overall beverage volume is within an appropriate range, the beverage volume range being for example determined by the type of the selected beverage and/or by the size of a typical receptacle for the selected beverage. If the selected parameter value is a temperature of a beverage component, the controller for example checks whether the selected temperature is compatible with the particular component and/or with the currently set temperature of other components of the selected beverage, etc.

If the outcome of the conformity check step 45 is positive, i.e. if the beverage parameter value selected by the user during the last customization step 43 is compatible with the selected beverage and/or with the other current beverage parameter values, then the beverage preparation machine is for example brought back to the customization step 43 in order to allow the user to modify his selection and/or to customize another beverage parameter, as illustrated in FIG. 6. Alternatively, the machine may be brought directly to the beverage preparation initiation step 47, where the machine preferably sets or adapts the preparation parameters on the basis of the currently selected beverage parameter values, and for example waits for a confirmation from the user to initiate the beverage preparation process on the basis of the current settings.

If the outcome of the conformity check step 45 is negative, i.e. if the beverage parameter value selected by the user during the last customization step 43 is not compatible with the selected beverage and/or with the other default and/or modified beverage parameter values, then at least one of the beverage parameter values is automatically corrected by the controller in a correction step 46. During the correction step 46, the controller for example sets the value of the beverage parameter customized by the user to an allowable value and/or sets the value of one or more other beverage parameters to a value compatible with the parameter value selected by the user during the last customization step 43. For example, if the selected value is a volume of a beverage component and the resulting volume of the multi-component beverage is outside a pre-defined volume range for the selected beverage, then the controller for example sets the value of the volume of another beverage component to a lower value, such that the resulting overall volume of the selected beverage is again within the allowable range. In another example, if the selected value is a temperature of a beverage component incompatible with, for example too much different from, the temperature of another beverage component, then the controller for example sets the value of the temperature of the other beverage component to a value closer to the selected temperature. Other corrections are possible within the frame of the invention, depending for example on the nature of the customized beverage parameter and/or on the conformity condition(s). Preferably, however, if the condition is a relationship between the values of two or more beverage parameters, the controller will modify the value of a beverage parameter other than the beverage parameter that was last customized by the user.

Preferably, during the correction step 46, the input device(s) corresponding to the corrected beverage parameter(s), if any, is/are moved to a position corresponding to the corrected value of the respective beverage parameter. The user is thereby informed of the automatic correction carried out by the beverage preparation machine.

Once the correction step 46 is performed, the machine is for example brought back to the customization step 43 in order to allow the user to further modify his selection and/or to customize another beverage parameter, as illustrated in FIG. 6. Alternatively, the machine may be brought directly to the beverage preparation initiation step 47, where the machine preferably sets or adapts the preparation parameters on the basis of the currently selected beverage parameter values, and for example waits for a confirmation from the user to initiate the beverage preparation process on the basis of the current settings.

If the outcome of the customization check step 44 is negative, i.e. if no customization was performed during the customization step 43 for example after a predefined delay, and/or if the last customization was checked for conformity and the necessary corrections were taken, then the machine is brought to the beverage preparation initiation step 47, where the machine preferably sets or adapts the preparation parameters on the basis of the currently selected beverage parameter values, and for example waits for a confirmation from the user to initiate the beverage preparation process on the basis of the current settings.

During the preparation initiation step 47, the machine preferably visually and/or acoustically informs the user through its user interface that the machine is ready to prepare the beverage, thereby inviting the user to initiate the beverage preparation by actuating a corresponding element of the user interface, for example by pushing a physical or virtual start button, such as for example a physical button of the machine user interface or a virtual start button displayed in a specific portion of a touch screen of the machine's display 3, identified for example by a specific icon or image. Alternatively or in combination thereof, the beverage preparation is automatically started after a defined delay has lapsed since the last modification of the parameters.

Once the beverage preparation is started, the machine controller automatically controls the beverage preparation arrangement to prepare and dispenses the beverage according to the previously selected parameter(s) in a dispensing step 48. Simultaneously to the dispensing step 48, the controller optionally automatically adapts the display and/or the one or more input devices of the beverage preparation machine in order to illustrate the beverage preparation and dispensing. The display is for example gradually modified and/or the one or more input devices are automatically displaced, in order to reflect the currently dispensed volume of one or more beverage ingredients.

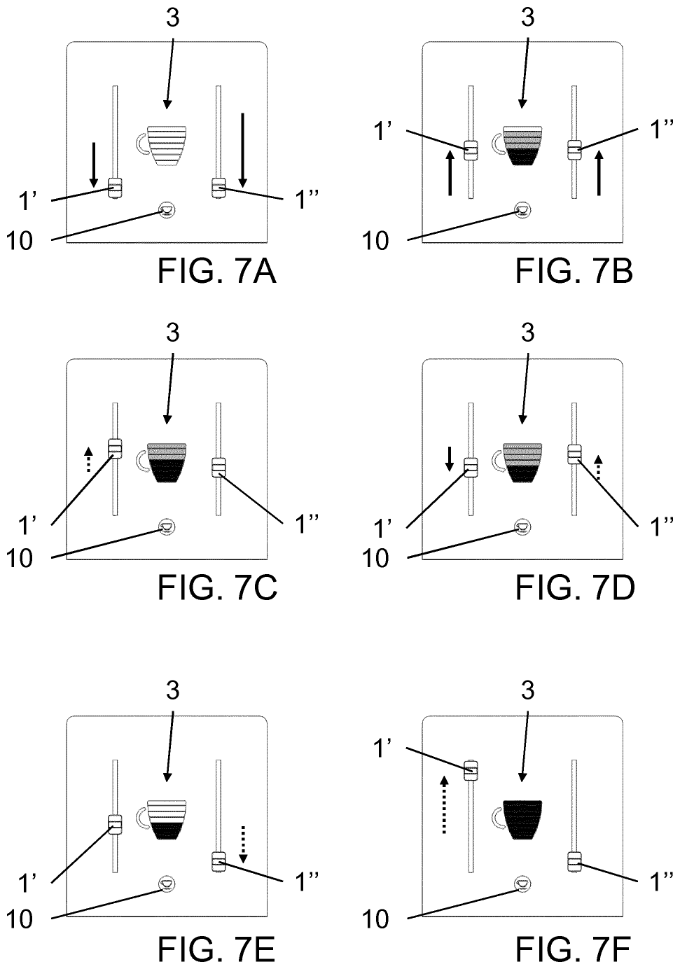

FIGS. 7A to 7F illustrate an example of a user interaction with the user interface of a beverage preparation machine according to an embodiment of the invention, wherein the user interface of the beverage preparation machine for example comprises two input devices 1′ and 1″ according to the invention. In FIGS. 7A to 7F, dotted arrows illustrate movements of the corresponding input device 1′ or 1″ initiated by the user, while plain arrows illustrate movements of the corresponding input device 1′ or 1″ initiated automatically by the beverage preparation machine, typically by the controller of the machine controlling the respective driver to move the respective input device 1′ or 1″, for example in response to a user action and/or to a beverage selection.

In an optional first stage illustrated at FIG. 7A, for example at machine power on and/or after a beverage preparation process is completed, the input devices 1′, 1″ of the user interface are moved to a stand-by or neutral position. As shown in FIG. 7B, once a beverage is manually and/or automatically selected, as explained above, the input devices 1′, 1″ are preferably moved automatically each to a position corresponding to the default value of the respective beverage parameter of the selected beverage, as determined by the beverage preparation machine. In the illustrated example, the selected beverage is for example a cappuccino and the default beverage parameter values are three volume units of coffee and three volume units of milk, for example foamed milk. Preferably, the machine's user interface comprises a display 3 displaying a schematic illustration of the selected beverage figuring the currently selected beverage parameter values.

With reference to FIG. 7C, the user then for example decides in a customization step to modify the recipe of the selected beverage by customizing for example one beverage parameter. The user for example moves the first input device 1′ by one position in order to increase the volume of coffee by one volume unit. The beverage preparation machine preferably checks whether the beverage parameter value selected by the user is acceptable, and since, for example, the total volume of the resulting beverage remains within a predetermined limit, for example a total of seven volume units, the beverage preparation machine doesn't perform any automatic correction. Preferably, the optional schematic illustration of the resulting beverage displayed on the display 3 is automatically updated accordingly by the beverage preparation machine.

As illustrated in FIG. 7D, the user decides in a further customization step to increase the volume of milk by one unit by moving up the second input device 1″ by one position. The beverage preparation machine then checks whether this last customization is compatible with the selected beverage and with the other selected parameter value(s). In the present case, the increase of milk volume selected by the user would result in an overall beverage volume larger than the maximal volume allowable for the selected beverage. The beverage preparation machine thus automatically corrects at least one other beverage parameter, typically the coffee volume, such that the total beverage volume is returned within the allowable conditions. As illustrated in the figure, the respective input device 1′ is preferably automatically moved to a position corresponding to the corrected beverage parameter value, for example to the corrected volume of coffee. Preferably, the display 3 is modified accordingly to reflect the new beverage parameter values.

In a next customization step, as illustrated in FIG. 7E, the user for example reduces the milk volume to zero by moving the second input device 1″ down to the lowest position. Since the total volume of the resulting beverage is below the predetermined limit, no correction of the volume of the other beverage component is initiated by the beverage preparation machine.

Optionally, however, for example if a cappuccino was automatically selected by the beverage preparation machine following the introduction in the machine of a milk capsule and a coffee capsule, or of a combined milk and coffee capsule, the beverage preparation machine may consider in a conformity check step that this last user selection is incompatible with the selected beverage. In a correction step, the beverage preparation machine may thus for example automatically increase the volume of milk component back to a predefined minimum and/or suggest to the user the selection of another beverage, such as a coffee for example, and for example to remove at least part of the previously introduced ingredients, if applicable. Alternatively or in combination thereof, the lowest position of an input device may be set by the machine beverage controller to correspond to a minimum volume of the corresponding beverage component different from zero if the selected beverage typically comprises such component, such as for example milk and/or coffee if the selected beverage is a cappuccino.

With reference to FIG. 7F, in the illustrated example the user may then increase the coffee volume to the maximum value in a next customization step, for example to seven volume units, by moving the left input device 1′ to the corresponding position. Again, this modification doesn't imply any automatic volume correction from the machine, since the condition of the beverage having a maximum total volume of seven volume units is met.

Once the user is satisfied with the set and/or selected parameters, beverage is for example initiated by the user by actuating a corresponding input element of the user interface, for example by pushing a physical or virtual start button, for example a virtual start button 10 displayed in a specific portion of a touch screen of the machine's display 3, identified for example by a specific icon or image.

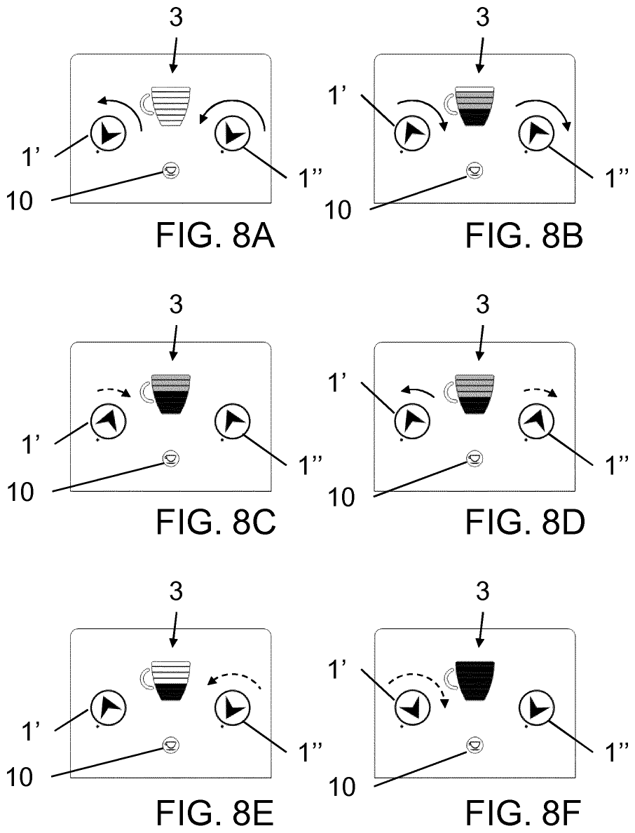

FIGS. 8A to 8F illustrate the same user interaction as illustrated by FIGS. 7A to 7F, but with the user interface of a beverage preparation machine according to another embodiment of the invention, where the first and second input devices 1′ and 1″ of the machine's user interface are rotating knobs instead of sliders. The user actions and machine reactions illustrated in these figures are however the same as the ones described above in relation to FIGS. 7A to 7F.

1. Beverage preparation machine, comprising:
a user interface for allowing a user interacting with the machine, the user interface comprising an input device for selecting a value of a beverage parameter within a value range, wherein the input device is a physical element, and wherein the position of the input device within the movement range corresponds to a selected value of the value range;
a beverage preparation arrangement configured for preparing a beverage from one or more ingredients taking into account the selected value;
a controller for controlling the user interface and the preparation arrangement; and
the user interface further comprises a driver connected to the input device for providing haptic feedback to a user moving the input device.

2. Beverage preparation machine according to claim 1, wherein the driver is configurable by the controller to adjust the haptic feedback to a nature of the beverage parameter and/or to a selected beverage to be prepared by the beverage preparation machine.

3. Beverage preparation machine according to previous claim 1, wherein the driver is configurable by the controller to define a finite number of discrete stable positions of the input device within the movement range, each discrete position corresponding to a different discrete value of the beverage parameter.

4. Beverage preparation machine according to claim 2, wherein the driver is configurable by the controller to limit the movements of the input device within a range smaller than the movement range.

5. Beverage preparation machine according to claim 1, wherein the driver is configured to be able to automatically move the input device.

6. Beverage preparation machine according to claim 1, wherein the user interface comprises:
a first input device for selecting a value of a first beverage parameter within a first value range, wherein the first input device is a physical element, and wherein the position of the first input device within the first movement range corresponds to a selected value of the first value range;
a first driver connected to the first input device for providing haptic feedback to a user moving the first input device and/or for moving the first input device;
a second input device for selecting a value of a second beverage parameter within a second value range, wherein the second input device is a physical element, such as a knob or a slider, movable within a preferably finite second movement range, and wherein the position of the second input device within the second movement range corresponds to a selected value of the second value range;
a second driver connected to the second input device for providing haptic feedback to a user moving the second input device and/or for moving the second input device; and
the beverage preparation arrangement being for preparing a beverage from one or more ingredients taking into account the selected value of the first beverage parameter and the selected value of the second beverage parameter.

7. Beverage preparation machine according to claim 1, wherein the controller is configured to check whether the selected value of the first beverage parameter and the selected value of the second beverage parameter fulfil a predefined beverage condition, and to automatically modify at least one of the selected value of the first beverage parameter and the selected value of the second beverage parameter, if the predefined beverage condition is not fulfilled.

8. Beverage preparation machine according to claim 1, wherein the controller is configured to automatically move the first input device to a position corresponding to an automatically modified value of the first beverage parameter and to automatically move the second input device to a position corresponding to an automatically modified value of the second beverage parameter.

9. Method for preparing a beverage with a beverage preparation machine comprising a user interface for allowing a user interacting with the machine, the user interface comprising an input device for selecting a value of a beverage parameter within a value range, wherein the input device is a physical element, and wherein the position of the input device within the movement range corresponds to a selected value of the value range, a beverage preparation arrangement configured for preparing a beverage from one or more ingredients taking into account the selected value, a controller for controlling the user interface and the preparation arrangement, and the user interface further comprises a driver connected to the input device for providing haptic feedback to a user moving the input device, the method comprising the steps of:
selecting a beverage to be prepared by the preparation machine; and
adjusting a haptic feedback of the input device to the selected beverage.

10. Method according to claim 9, wherein adjusting the haptic feedback comprises configuring a force feedback to define a finite number of discrete stable positions of the input device.

11. Method according to claim 9, wherein adjusting the haptic feedback comprises configuring a force feedback to limit the movements of the input device to a range smaller than the movement range.

12. Method according to claim 9, further comprising the steps of:
checking whether the selected value is compatible with the selected beverage and/or with values of other beverage parameters of the selected beverage;
correcting the selected value and/or a value of the other beverage parameters if the result of the previous step of checking is negative; and
automatically moving an input device of the user interface if a value of a beverage parameter selectable through the input device is corrected in the previous step of correcting.
